(19) United States
(12) Patent Application Publication
(10) Pub. No.: US 2021/0195336 A1
(43) Pub. Date: Jun. 24, 2021

(54) Aircraft Stereo Headset for 3D Audio Using Four-Wire Plug

(71) Applicant: Orbit Communication Systems Ltd., Netanya (IL)

(72) Inventors: Mark YAROSLAVSKI, Netanya (IL); Max GADOT, Kfar Saba (IL); Michael ELBAZ, Tel Mond (IL)

(21) Appl. No.: 17/128,236

(22) Filed: Dec. 21, 2020

Related U.S. Application Data
(60) Provisional application No. 62/952,541, filed on Dec. 23, 2019.

(51) Int. Cl. H04R 5/04; H04R 5/033

(52) U.S. Cl. CPC H04R 5/04; H04R 5/033; H04R 2460/01; H04R 2420/01; H04R 2420/09

(57) ABSTRACT

A system for transferring stereo audio required for 3D audio presentation to pilots, allows a legacy four conductor headset plug to carry at least five signals. At least five signals are needed to support stereo audio and microphone, in place of mono audio presented to the pilot and microphone. The headset microphone negative and speaker-left negative lines are connected, preferably only at the headset plug and jack. A low-to-high impedance microphone amplifier is employed on the microphone line, and high impedance earphones are used. This combination reduces unwanted crosstalk between the speaker and the microphone signals to acceptable levels, while providing stereo audio to a user. Replacement of a four-conductor headset plug with a headset plug containing more conductors is problematic, as a change of the headset plug would require expensive ejection seat re-testing.

### FIELD OF THE INVENTION

The present invention generally relates to stereophonic sound reproduction in aircraft, and in particular, it concerns transmission of stereo audio and microphone signals using a standard legacy four-wire plug connection.

### BACKGROUND OF THE INVENTION

Referring now to FIG. 1, a schematic diagram of a conventional, current standard military pilot headset plug 104. Four conductors are used, known as a four-wire plug. Two conductors, speaker positive (102P, SPK+) and speaker negative (102N, SPK−), are used to transfer monaural (mono) sound. In monaural (mono) sound one single audio channel is used. The mono audio can be reproduced through more than one speaker, but all speakers are still reproducing the same copy of the single audio signal. A standard military pilot headset has two speakers, referred to as earphones.

The headset plug 104 also includes two other conductors, microphone positive (100P, MIC+) and microphone negative (100N, MIC−), that are used to transmit the pilot's voice from the microphone. In fighter aircraft a conventional low impedance dynamic microphone located inside the pilot's oxygen mask is utilized.

### SUMMARY

A system for transferring stereo audio required for 3D audio presentation to pilots, allows a legacy four conductor headset plug to carry at least five signals. At least five signals are needed to support stereo audio and microphone, in place of mono audio presented to the pilot and microphone. The headset microphone negative and speaker-left negative lines are connected, preferably only at the headset plug and jack. A low-to-high impedance microphone amplifier is employed on the microphone line, and high impedance earphones are used. This combination reduces unwanted crosstalk between the speaker and the microphone signals to acceptable levels, while providing stereo audio to a user. Replacement of a four-conductor headset plug with a headset plug containing more conductors is problematic, as a change of the headset plug would require expensive ejection seat re-testing.

According to the teachings of the present embodiment there is provided a military flight audio system including: high impedance earphones including a first speaker and a second speaker, a low impedance microphone, an amplifier operationally connected to the low impedance microphone, and an audio plug having first, second, third, and fourth conductors, wherein: the first conductor is coupled to a first input of the first speaker, the second conductor coupled to a first input of the second speaker, the fourth conductor coupled to a first output of the amplifier, and the third conductor coupled to a second input of the first speaker, a second input of the second speaker, and a second output of the amplifier.

In an optional embodiment, the third conductor is coupled by connecting the second input of the first speaker, the second input of the second speaker, and the second output of the amplifier at a location internal to the audio plug.

In another optional embodiment, the high impedance earphones have an impedance on the order of 150 ohm and an output of the amplifier has an impedance on the order of 300 ohm.

In another optional embodiment, the first speaker is a left stereo headset earphone and the second speaker is an associated right stereo headset cup.

In another optional embodiment, the audio plug is selected from the group consisting of: a military pilot headset plug, and an Amphenol U-92 A/U plug.

In another optional embodiment, the first conductor is a speaker positive connection, the second conductor is a speaker negative connection, the third conductor is a microphone negative connection, and the fourth conductor is microphone positive connection.

In another optional embodiment, further including an audio jack coupling the audio plug to an audio management module, the audio jack selected from the group consisting of: a military pilot headset plug, and an Amphenol U-93 A/U jack. In another optional embodiment, the audio jack has fifth, sixth, seventh, and eighth conductors, the fifth conductor coupled to the first conductor and configured for a first audio signal, the sixth conductor coupled to the second conductor and configured for a second audio signal, the eighth conductor coupled to the fourth conductor and configured for a fourth audio signal, and the seventh conductor coupled to the third conductor and configured for a third audio signal. In another optional embodiment, the first audio signal is a left stereo positive signal, the second audio signal is a right stereo positive signal associated with the left stereo positive signal, the fourth audio signal is a microphone positive signal, and the third audio signal is a common ground.

In another optional embodiment, the amplifier has an amplification selected from the group consisting of: on the order of 40 dB, on the order of 50 dB, and on the order of 60 dB.

In another optional embodiment, the first and second speakers include noise reduction modules. In another optional embodiment, the noise reduction modules are active noise reduction (ANR) modules and the first and third conductors and the second and third conductors each pair provide phantom power to the active noise reduction modules.

In another optional embodiment, the third conductor and the fourth conductor provide phantom power to the microphone amplifier.

### BRIEF DESCRIPTION OF FIGURES

The embodiment is herein described, by way of example only, with reference to the accompanying drawings, wherein:

FIG. 1 is a schematic diagram of a conventional military pilot headset plug.

FIG. 2 is a schematic wiring diagram of conventional mono audio military pilot headset and plug.

FIG. 3 is a schematic diagram of an exemplary embodiment of a system implementing stereo audio with a legacy military pilot headset and plug according to the invention.

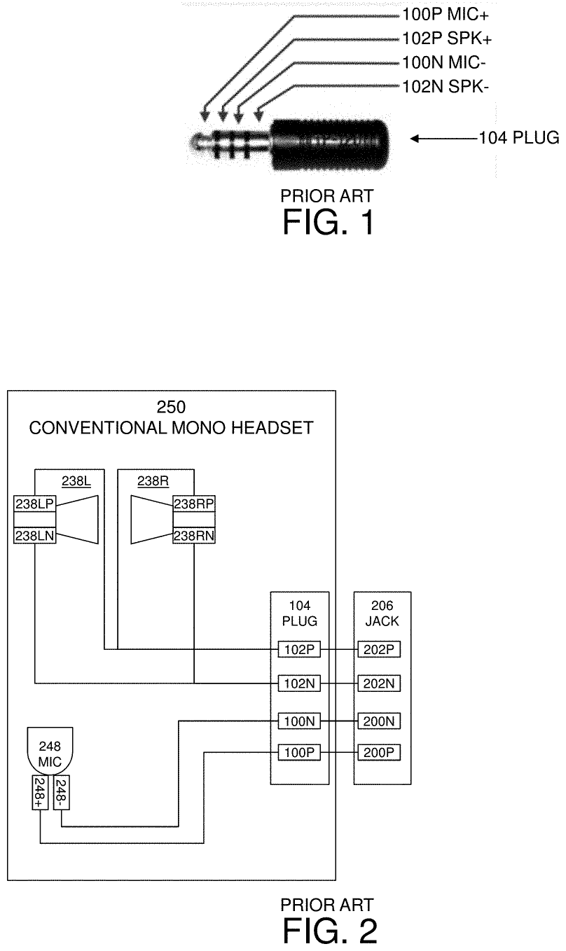

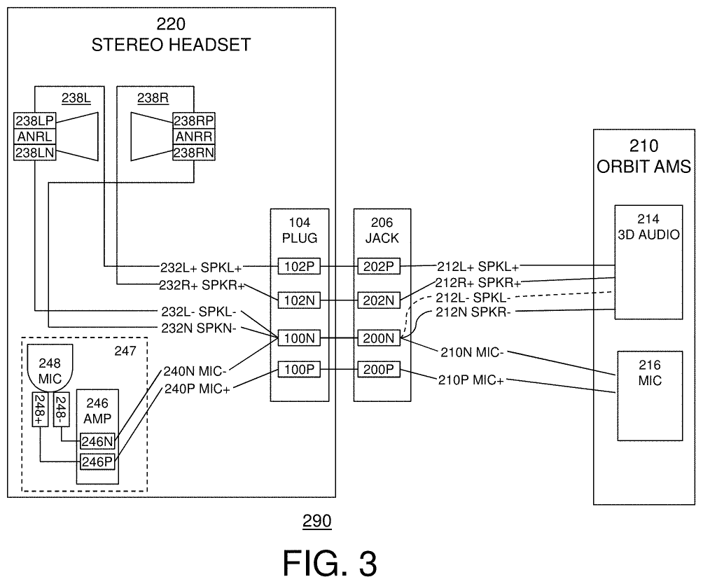

### DETAILED DESCRIPTION—FIRST EMBODIMENT—FIG. 1 TO FIG. 3

The principles and operation of the system according to a present embodiment may be better understood with reference to the drawings and the accompanying description. A present invention is a system for transferring stereo audio, that is required for spatial 3D audio, via a legacy conventional, current standard military pilot headset plug, transferring at least five signals via a standard four conductor connection.

The system facilitates stereo audio that is required for spatial three-dimensional (3D) audio providing directionality for perceived audio, as compared to current mono audio. 3D audio supports radio separation, hence communication intelligibility, and increased survivability, for example directional audio warning cues from ground missile threats. One example of 3D audio is Orbit's (Orbit Communications Systems Ltd, Netanya, Israel) 3D Audio technology based on utilizing Head Related Transfer Functions (HRTF) for reproduction of 3D sound in stereo headsets. By providing the pilot with directional audio cues, the spatial direction of the sound source can be perceived.

In general, a military flight audio system of the current embodiment (290) includes: high impedance earphones including a first speaker and a second speaker, a low impedance microphone, an amplifier operationally connected to the low impedance microphone, and an audio plug (104) having first (102P, SPKL+), second (102N, SPKR+), third (100N, SKL−, SPKN−, MIC−), and fourth (100P, MIC+) conductors. The first conductor is coupled to a first input (SPKL+) of the first speaker (238L), the second conductor coupled to a first input (SPKR+) of the second speaker (238R), the fourth conductor coupled to a first output (MIC+) of the amplifier (246P), and the third conductor coupled to a second input (SPKL−) of the first speaker (238L), a second input (SPKR−) of the second speaker (238R), and a second output (246N) of the amplifier (246).

A significant problem in achieving high quality stereo signals in aircraft is the high crosstalk occurring between microphone and earphone channels as a result of limitations of using a conventional four-wire plug connector to transfer five signals. In particular, connection of a speaker negative signal to a microphone negative signal causes unacceptable crosstalk. Audio channel signals are related to a left earphone element, a right earphone element, and a microphone.

This crosstalk is a signal leakage from one audio channel to another audio channel. Typically, crosstalk between the microphone channel and mono earphone channel in military aircraft is approximately −40 dB due to conventional wiring methods. In general, separation between the earphone channels and the microphone channel of less than 40 dB is not acceptable.

Good crosstalk separation is not difficult to achieve in today's general audio systems. However, wiring for a headset connection with a four-wire plug used in most aircraft prevents delivering high quality stereo audio to aircrew. At first glance, there seems no problem supplying stereophonic audio to an aircrew member using a common negative wire for the left and right earphones and the microphone. There are adequate wires in a four-wire plug to close all needed electrical circuits. However, upon further examination, the common negative wire will cause unacceptable crosstalk between the microphone and the earphone channels at least in part due to the high electrical current of the earphone channels compared to the lower electrical current of microphone channel.

Replacement of a four-conductor headset plug with a five or six-conductor headset plug is problematic, as this implementation would require expensive ejection seat retesting due to the fact that during pilot ejection the headset plug separates from the jack.

Typical engineering implementations in a variety of fields to re-use existing conductors, such as the analog audio four-wire plug conductor, for additional capability focus on implementing digital signals via legacy conductors. Digital implementations require the addition of processing (hence hardware, software, and supplied power) to both sides of the conductor, as well as additional hardware on one or more sides for analog-to-digital and digital-to-analog conversion.

While the current description uses an example of a military pilot headset and corresponding plug-jack combination, this implementation is not limiting. Implementations can be used for non-military, commercial applications. In addition, implementations can be used for devices other than audio headsets, and applications using additional and/or other configurations of conductors. For example, a four conductor commercial jack configuration from tip to sleeve of respective left, right, ground, and mic signals.

An innovative configuration of connections and support hardware modules allows a legacy four conductor military pilot headset plug 104 to carry at least five signals. Additional signals, beyond four, are needed to support stereo audio, in place of the current mono audio presented to the pilot. The current headset plug, jack, and associated hardware for a military pilot headset have undergone extensive ejection seat testing. Upon ejection of the pilot, the headset plug (U-92) must detach from the headset (socket) jack (U-93). Using a different plug and jack to support additional conductors, in place of the current standard plug, would entail expensive ejection seat testing with the different plug and jack hardware. Thus, if the current hardware can be used, acceptance and deployment can be significantly less expensive than using a different hardware connector.

A feature of the current embodiment is the use of the existing analog legacy four conductor military pilot headset plug 104 to carry at least five analog signals. Existing, already tested hardware can be used with minimal changes to provide stereo audio to a user (such as a pilot).

Operational benefits of spatial 3D audio for pilots include:
Survivability—Directional Radar Warning Receiver (RWR) cues to ground and air threats, fully synchronized to head-mounted display (HMD) visual cues.
Radio separation—Enhances intelligibility of multiple radio channels.
Locating wingmen—Directional flight formation radio allows locating wingmen in a quicker manner. Especially when formation breaks or during a dogfight.
Safety—Directional Anti-Collision warnings between aircraft flying in formation.
Locating targets—Infra-red (IR) missile tones for locating enemy targets.
Safety—Directional audio alerts increase flight safety, for example: left/right engine alert.

Referring now to the drawings, FIG. 2 is a schematic diagram of a conventional mono (single audio channel) headset 250 with a legacy military pilot headset plug 104. Elements of the drawings have been drawn for clarity of connections and configuration, not to scale or as the actual devices are built. For example, vertical arrangement on the page of elements of the plug 104 are not in the same order as the order of the physical connections shown in FIG. 1. Instead, the elements are arranged for clarity of connections between elements in the figures. For clarity, to assist with understanding the innovative configuration of stereo headset 220, described below, elements of the current figure are drawn with respect to left and right earphones (speakers). One skilled in the art will realize that the designation of left and right is only for clarity of reference, as the audio in a conventional military plug is monaural.

A mono headset 250 includes a left earphone 238L and a right earphone 238R, for receiving the single speaker signal. The left earphone 238L includes a left speaker positive input 238LP, a left speaker negative input 238LN Similarly, the right earphone 238R includes a right speaker positive input 238RP, a right speaker negative input 238RN. The left and right earphones (238L, 238R) are connected in parallel so that the speaker signal is identical to both earphones providing mono audio. Conventional, standard, military low impedance speakers on the order of 19 ohm each, with an impedance of 9.5 ohm as the two mono speakers are connected in parallel. The left and right earphones (238L, 238R) are non-limiting examples used in the current description for speakers, and more generally for audio output devices.

The mono headset 250 also includes a microphone (248, MIC) providing a microphone signal. The microphone 248 includes a microphone positive terminal 248+ and a microphone negative terminal 248−. The microphone 248 is typically a low impedance, 5 ohm, dynamic microphone located inside the pilot's oxygen mask,

A plug connector 104 is typically a male connector. In the currently exemplary implementation of a military pilot headset, an Amphenol U-92 A/U plug (available from Amphenol Nexus Technologies, Stamford, Conn., USA) can be used. As described above, the plug 104 has four conductive areas that in standard implementations are plug speaker-positive (102P, SPK+), plug speaker-negative (102N, SPK−), plug microphone-positive (100P, MIC+) and plug microphone-negative (100N, MIC−).

In a conventional implementation of a mono headset, the plug 104 is connected as follows:
The plug speaker-positive 102P to both of the positive speaker inputs (the left speaker positive input 238LP and the right speaker positive input 238RP),
the plug speaker-negative 102N to both of the negative speaker inputs (the left speaker negative input 238LN the right speaker negative input 238RN),
the plug microphone-positive 100P to the microphone positive 248+, and
the plug microphone-negative 100N to the microphone negative 248−.

Corresponding to the plug 104 connector is a jack 206 connector. Typically, the jack 206 connector is a female connector, also known in the field as a “socket”. In the currently exemplary implementation of a military pilot headset, an Amphenol U-93 A/U jack can be used. The jack 206 has four conductive areas that in standard implementations are jack speaker positive 202P, jack speaker negative 202N, jack microphone positive 200P, and jack microphone negative 200N.

When the plug 104 connector is inserted into the jack 206 connector, the conductors of the plug 104 contact the conductors of the jack 206, as is known in the field:
the plug speaker-positive 102P, to the jack speaker-positive 202P,
the plug speaker-negative 102N, to the jack speaker-negative 202N,
the plug microphone-negative 100N to the jack microphone-negative 200N, and
the plug microphone-positive 100P to the jack microphone-positive 200P.

Referring now to the drawings, FIG. is a schematic diagram of an exemplary embodiment of a system 290 implementing stereo audio with a legacy military pilot headset plug 104 and jack 206. Elements of the drawings have been drawn for clarity of connections and configuration, not to scale or as the actual devices are built.

As noted above, the elements of the conventional mono headset 250 of FIG. 2 were laid out for clarity to correspond to the innovative configuration of elements, hardware, and connections of the current figure's stereo headset 220, described below.

A stereo headset 220 includes a left earphone 238L and a right earphone 238R, each for receiving respective left and right speaker signals. The left earphone 238L includes a left speaker positive input 238LP, a left speaker negative input 238LN, and optionally an active noise reduction (ANR) module left ANRL. Similarly, the right earphone 238R includes a right speaker positive input 238RP, a right speaker negative input 238RN, and optionally an ANR module right ANRR.

The stereo headset 220 also includes a low impedance microphone (248, MIC) located inside the pilot's oxygen mask providing a microphone signal, connected to a microphone amplifier (246, AMP). The amplifier 246 is typically located outside the oxygen mask. The amplifier 246 has microphone positive 246P and microphone negative 246N connections for the respective microphone 248 connections (the microphone positive terminal 248+ and the microphone negative terminal 248−). One skilled in the art will realize that the connections 246N and 246P towards the plug 104 represent the microphone signals amplified and with high impedance as seen by connection to the MIC module 216.

An audio input module 247 is defined including the microphone 248 and the amplifier 246.

An audio management system can include generation, control, mixing, signal processing and distribution of one or more audio signals, receiving of microphone inputs, and optional functions such as power management and supply. An exemplary audio management system used in this description is an Orbit audio management system (AMS) 210. The AMS 210 includes a 3D audio module 214. The 3D audio module 214 provides functions including signal processing, control, and generation of at least two signals, a stereo signal, for example as follows:
a left stereo signal positive (SPKL+) on an AMS speaker-left positive line 212L+ to the jack speaker-positive 202P,
a right stereo signal positive (SPKR+) on an AMS speaker-right positive line 212R+ to the jack speaker-negative 202N,
a left stereo signal negative (SPKL−) on an AMS speaker left negative line 212L− to the jack microphone-negative 200N,
a right stereo signal negative (SPKR−) on the AMS speaker right negative line 212N also to the jack microphone-negative 200N,
a mic module 216 positive signal (MIC+) on an AMS microphone-positive 210P line to the jack microphone-positive 200P, and
a mic module 216 negative signal (MIC−) on an AMS microphone-negative 210N line also to the jack microphone-negative 200N.

Optionally, module 214 also provides phantom power between the speaker-negative line 212N and the speaker-left positive line 212L+, and between the speaker-negative line 212N and the speaker-right positive line 212R+, to power the ANR modules (the ANR module left ANRL and the ANR module right ANRR) in the headset.

Optionally, the speaker negative line 212N can be separated to speaker-left negative line 212L- and speaker-right negative line 212N in order to achieve higher separation between the left and right speaker signals.

The AMS 210 also includes a microphone module 216. The microphone module 216 can provide phantom power between the microphone positive line (210P, MIC+) and the microphone negative line (210N, MIC−), to power the microphone amplifier 246.

A configuration of connections and support hardware modules allows a legacy four conductor plug 104 to carry at least five or six signals is as follows:
The left speaker positive input 238LP is connected via a headset speaker-left positive line 232L+ (SPKL+) to the plug 104 speaker-positive 102P conductor.
The right speaker positive input 238RP is connected via a headset speaker-right positive line 232R+ (SPKR+) to the plug 104 conductor 102N.
The left speaker negative 238LN is connected via a headset speaker-left negative line 232L− (SPKL−) also to the plug 104 microphone-negative 100N conductor.
The right speaker negative 238RN is connected via a headset speaker-right negative line 232N (SPKR−) also to the plug 104 microphone-negative 100N conductor.

From the microphone amplifier 246, the microphone negative 246N connection is via a microphone-negative line 240N (MIC−) also to the plug 104 microphone-negative 100N conductor, and the microphone positive 246P connection is via a microphone-positive line 240P (MIC+) to the plug 104 microphone-positive 100P conductor.

In an alternative configuration, instead of the above-described six signals (212L+, 212R+, 212L−, 212N, 210N, 210P), transferring stereo audio via a legacy conventional four conductor connection can be implemented using five signals on the jack side, by eliminating the AMS speaker-left negative line 212L−, as the left speaker negative 238LN is connected via the headset speaker-left negative line 232L− to the plug 104 microphone-negative 100N conductor. Thus, reusing the common negative connection of the plug microphone-negative 100N and the jack microphone-negative 200N. Although the five-signal implementation may have more crosstalk between the left and right speaker channels, as compared to the six-signal implementation (thus reducing the stereo effect because of a reduction in the separation of left/right channels), operation of the five-signal implementation of the current embodiment can still be within an acceptable level of separation. Combining (five signals) or separating (six signals) implementation is dependent on the desired implementation and operation.

In the current exemplary embodiment of providing stereo to a headset, six signals are shown being transferred via four conductors (four conductor plug). The signals can generally be referred to as:
MIC− (microphone negative)
MIC+ (microphone positive)
SPKL+ (speaker left positive)
SPKR+ (speaker right positive)
SPKL− (speaker left negative)
SPKN− (speaker right negative) The designator “SPKN−” is used instead of “SPKR−” as this is used as a common negative in both the six-signal and five-signal implementations.)

On the plug side, the MIC− (microphone-negative line 240N), SPKN− (headset speaker-right negative line 232N) and SPKL− (headset speaker-left negative line 232L−) are connected to same conductor (microphone negative 100N), thus no plug change is required. This configuration saves the cost of ejection seat retesting (saving significant expense per aircraft type). Correspondingly, on the jack side, the MIC− (AMS microphone-negative 210N), SPKR− (AMS speaker-negative line 212N), and SPKL− (AMS speaker left negative line 212L) lines are connected to the same conductor (jack microphone-negative 200N).

Normally, such connecting (of MIC− and SPKN− lines to the same plug conductor 100N) causes unacceptable crosstalk between microphone and speaker signals. In particular, crosstalk separation of at least 40 dB is desired (required) between the microphone and speaker signals, which is not achieved when these lines are simply connected.

In order to overcome this problem and achieve acceptable crosstalk between the microphone and speaker signals, the following features can be implemented:

1) Connection of the MIC− (microphone-negative line 240N), the SPKN− (headset speaker-right negative line 232N), and the SPKL− (headset speaker left negative line 232L) is done preferably only within the plug 104 and correspondingly only within the jack 206 (within 100N and 200N in the current figure). In general, the further away from the entrance to the plug 104 and entrance to the jack 206 (further away from the plug microphone negative 100N conductor) the connection is implemented, the more crosstalk there will be between the microphone and speaker signals. The maximum distance the connection can be from the entrance conductor depends on the acceptable level of crosstalk allowed.

2) Use of a low-to-high impedance amplifier (amp 246) on the microphone line between the mic 248 and the plug 104. In the context of this document, the term “low-impedance” for the microphone refers to impedance of 5 ohm, or on the order of 5 ohm. In the context of this document, the term “high-impedance” for the microphone refers to typical impedances of 150 ohm or higher. The amplification is typically greater than 50 dB, preferably on the order of 60 dB. The terms “high impedance” and “low impedance” in reference to the microphone will be understood by one skilled in the art.

3) Using high impedance earphone speakers for the left 238L and right 238R earphones (in place of standard military low impedance speakers on the order of 19 ohms each, with an impedance of 9.5 ohms as the earphones are connected in parallel). In this context, high impedance for speakers/earphones is typically 150 ohm or above, preferably on the order of 300 or 600 ohm (using standard, available components). The terms “high impedance” and “low impedance” in reference to the earphones will be understood by one skilled in the art.

One of the results of the combination of the above three features is reducing current carried in the connected conductor, thereby achieving acceptable signal separation between the microphone and speaker signals.

Embodiments can be used with or without active noise reduction (ANR). Different methods of noise reduction can be used to reduce the noise, and are dependent on the application and noise sources in the environment, such as in an aircraft cockpit. Noise reduction methods can include:

1. Microphone Noise Reduction—Reducing noise that enters the pilot's microphone, so that the pilot's voice without noise is transmitted over the radio (or intercom) for increased intelligibility. ANR can be implemented within the AMS 210.

2. Active Noise Reduction Headphones—Reducing ambient noise reaching the pilot's ears. Implemented within the headset (not part of the AMS 210), shown in the current figure as left ANR module ANRL and right ANR module ANRR. This reduction is relevant for both helicopter and fighter aircraft. Solutions are available off the shelf for transport and civil aviation.

3. Electrical Noise Reduction—Reducing electrical noise from aircraft auxiliary systems, for example, induced on the analog audio input lines to the AMS 210 causing the pilot to hear high-pitched tones. This reduction can be especially relevant in fighter aircraft. One option for implementation is to use dedicated filters within the AMS 210 to reduce and/or eliminate this source of noise.

According to the teachings of the present embodiment there is provided a system (290) for conducting multiple analog signals (SPKL+, SPKR+, SPKL−, SPKN, MIC−, MIC+), the system including: an audio plug (104) having at least one conductor (100N) receiving two or more signal leads (232L, 232N, 240N) at a common location (100N), the two or more signal leads being shorted at a given distance from the common location.

In an optional embodiment, wherein the given distance is less than a maximum threshold distance which is pre-determined to prevent crosstalk between the two or more signal leads from exceeding a given acceptable crosstalk level.

In another optional embodiment, wherein the maximum threshold distance is on the order of 5 centimeters and the given acceptable crosstalk level is 30 dB.

In another optional embodiment,
(a) the audio plug (104) has first (102P, SPKL+), second (102N, SPKR+), third (100N, SKL−, SPKN−, MIC−), and fourth (100P, MIC+) conductors,
(b) the first conductor coupled to a first input (SPKL+) of a first speaker (238L),
(c) the second conductor coupled to a first input (SPKR+) of a second speaker (238R),
(d) the fourth conductor coupled to a first output (MIC+) of an audio input module (MIC), and
(e) the third conductor coupled to a second input (SPKL−) of the first speaker (238L), a second input (SPKR−) of the second speaker (238R), and a second output (MIC−) of the audio input module (MIC).

In another optional embodiment, the first speaker is a left stereo headset cup and the second speaker is an associated right stereo headset cup.

In another optional embodiment, the audio plug is selected from the group consisting of: a military pilot headset plug, and an Amphenol U-92 A/U plug.

In another optional embodiment, further including an audio jack (206) coupling the audio plug to an audio management module, the audio jack selected from the group consisting of: a military pilot headset plug, and an Amphenol U-93 A/U jack.

In another optional embodiment, wherein the first conductor is a speaker positive connection, the second conductor is a speaker negative connection, the third conductor is an audio input module negative connection, and the fourth conductor is an audio input module positive connection.

In another optional embodiment, including:
an audio jack (206) having fifth (202P), sixth (202N), seventh (200N), and eighth (200P) conductors,
the fifth conductor coupled to the first conductor and configured for a first audio signal,
the sixth conductor coupled to the second conductor and configured for a second audio signal,
the eighth conductor coupled to the fourth conductor and configured for a fourth audio signal, and
the seventh conductor coupled to the third conductor and configured for a third audio signal.

In another optional embodiment, wherein:
the first audio signal is a left stereo positive signal,
the second audio signal is a right stereo positive signal associated with the left stereo positive signal,
the fourth audio signal is a microphone positive signal, and
the third audio signal is a common ground.

In another optional embodiment, wherein the third conductor (100N) is coupled by electrically shorting the second input (SPKL−) of the first speaker (238L), the second input (SPKR−) of the second speaker (238R), and the second output (MIC−) of the audio input module (MIC) at a location selected from the group consisting of: internal to the audio plug (104), and adjacent to the audio plug.

In another optional embodiment, wherein the audio input module includes a low impedance microphone (248) and a low-to-high impedance amplifier, the low impedance microphone coupled to a low impedance input of the low-to-high impedance amplifier, the first and second outputs of the audio module being high impedance outputs of the low-to-high impedance amplifier.

In another optional embodiment, wherein the a low-to-high impedance amplifier has an amplification selected from the group consisting of: on the order of 40 dB, on the order of 50 dB, and on the order of 60 dB.

In another optional embodiment, wherein the first and second speakers are high impedance speakers, the high impedance selected from the group consisting of: substantially 300 Ohms, on the order of 300 Ohms, substantially 600, and on the order of 600 Ohms.

In another optional embodiment, wherein the first and second speakers include noise reduction modules

In another optional embodiment, wherein the noise reduction modules are active noise reduction (ANR) modules and the first conductor and the third conductor provide phantom power to the active noise reduction modules.

In another optional embodiment, wherein the third conductor and the fourth conductor provide phantom power to the audio input module (MIC).

According to the teachings of the present embodiment there is provided a system (290) for conducting multiple analog signals (SPKL+, SPKR+, SPKL−, SPKN, MIC−, MIC+), the system including: an audio jack (206) having at least one conductor (200N) receiving two or more signal leads (212L−, 212N, 210N) at a common location (200N), the two or more signal leads being shorted at a given distance from the common location

In an optional embodiment, further including an audio management module (AMS, 210):

(a) providing a first audio signal (SPKL+, 212L) coupled via the audio jack (206) to a first input (SPKL+) of a first speaker (238L),

(b) providing a second audio signal (SPKR+, 212R) coupled via the audio jack (206) to a first input (SPKR+) of a second speaker (238R),

(c) receiving a fourth audio signal (MIC+, 210P) coupled via the audio jack (206) from a first output (MIC+) of an audio input module (AMP 246), and

(d) receiving a third audio signal (210N, MIC−) coupled via the audio jack (206) from a second output (MIC−) of the audio input module (AMP 246),

(e) providing a speaker negative line (212N) coupled via the audio jack (206) to both a second input (SPKL−) of the first speaker (238L) and a second input (SPKR−) of the second speaker (238R),

the third audio signal coupled to the speaker negative line.

In another optional embodiment, wherein the first audio signal is a speaker-left positive line, the second audio signal is a speaker-right positive line, the fourth audio signal is a microphone positive line, and the third audio signal is a microphone negative line.

In another optional embodiment, wherein the audio management module further provides a speaker-left negative line (212L−, SPKL−) coupled to the second input of the first speaker, and the speaker negative line couples only to the second input of the second speaker, the microphone negative line, the speaker-left negative line, and the speaker negative line are commonly coupled.

In another optional embodiment, wherein the audio management module provides phantom power via one or more pairs of lines selected from the group consisting of:

(a) the speaker-left positive line and the speaker negative line,

(b) the speaker-right positive line and the speaker negative line, and

(c) the microphone positive line and the microphone negative line.

In another optional embodiment, wherein the third audio signal is coupled to the speaker negative line by electrically shorting the third audio signal and the speaker negative line at a location selected from the group consisting of: internal to an audio jack (206), and adjacent to the audio jack. In another optional embodiment, wherein the audio management module (AMS 210) provides phantom power to the first and second speakers (238L, 238R) via the first and third audio signals. In another optional embodiment, wherein the audio management module (AMS 210) provides phantom power to the audio input module (MIC) via the third and fourth audio signals.

While the current embodiment has been described with reference to a standard military pilot headset, this description is not limiting. Based on the current description, one skilled in the art will be able to implement the current invention for other configurations and deployments, including, but not limited to other military use, transportation, home, and consumer use.

The above description uses a preferred embodiment of using the stereo audio system 290 for 3D audio, however, this embodiment is not limiting. Embodiments of the system 290 can be used for non-3D audio, that is, a conventional stereo signal. The choices used to assist in the description of this embodiment should not detract from the validity and utility of the invention. It is foreseen that more general and alternative choices can be made, depending on the application.

The use of simplified calculations to assist in the description of this embodiment should not detract from the utility and basic advantages of the invention.

Note that a variety of implementations for modules and processing may be possible, depending on the application. The above description of modules is not limiting, and modules may be implemented at one or more locations. The above-described module functions may be combined and implemented as fewer modules or separated into sub-functions and implemented as a larger number of modules. Based on the above description, one skilled in the art will be able to design an implementation for a specific application.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A military flight audio system comprising:
(a) high impedance earphones including a first speaker and a second speaker,
(b) a low impedance microphone,
(c) an amplifier operationally connected to said low impedance microphone converting the low impedance microphone signal to a high impedance microphone signal, and
(d) an audio plug having first, second, third, and fourth conductors,
wherein:
(i) said first conductor is coupled to a first input of said first speaker,
(ii) said second conductor coupled to a first input of said second speaker,
(iii) said fourth conductor coupled to a first output of said amplifier, and
(iv) said third conductor coupled to a second input of said first speaker, a second input of said second speaker, and a second output of said amplifier.

2. The system of claim 1 wherein said third conductor is coupled by connecting said second input of said first speaker, said second input of said second speaker, and said second output of said amplifier internal to said audio plug.

3. The system of claim 1 wherein said high impedance earphones have an impedance on the order of 150 ohm and said high impedance microphone signal has an impedance on the order of 300 ohm.

4. The system of claim 1 wherein said first speaker is a left stereo headset earphone and said second speaker is an associated right stereo headset cup.

5. The system of claim 1 wherein said audio plug is selected from the group consisting of:
(a) a military pilot headset plug, and
(b) an Amphenol U-92 A/U plug.

6. The system of claim 1 wherein said first conductor is a speaker positive connection, said second conductor is a speaker negative connection, said third conductor is a microphone negative connection, and said fourth conductor is a microphone positive connection.

7. The system of claim 1 further including an audio jack coupling said audio plug to an audio management module, said audio jack selected from the group consisting of:
(a) a military pilot headset plug, and
(b) an Amphenol U-93 A/U jack.

8. The system of claim 7 wherein:
said audio jack has fifth, sixth, seventh, and eighth conductors,
said fifth conductor coupled to said first conductor and configured for a first audio signal,
said sixth conductor coupled to said second conductor and configured for a second audio signal,
said eighth conductor coupled to said fourth conductor and configured for a fourth audio signal, and
said seventh conductor coupled to said third conductor and configured for a third audio signal.

9. The system of claim 8 wherein:
said first audio signal is a left stereo positive signal,
said second audio signal is a right stereo positive signal associated with said left stereo positive signal,
said fourth audio signal is a microphone positive signal, and
said third audio signal is a common ground.

10. The system of claim 1 wherein said amplifier has an amplification selected from the group consisting of:
(a) on the order of 40 dB,
(b) on the order of 50 dB, and
(c) on the order of 60 dB.

11. The system of claim 1 wherein said first and second speakers include noise reduction modules

12. The system of claim 11 wherein said noise reduction modules are active noise reduction (ANR) modules and a pair of said first and third conductors and a pair of said second and third conductors provide phantom power to said active noise reduction modules.

13. The system of claim 1 wherein said third conductor and said fourth conductor provide phantom power to said amplifier.
